(19) United States
(12) Patent Application Publication
(10) Pub. No.: US 2024/0135392 A1
(43) Pub. Date: Apr. 25, 2024

(54) System and Method for Real Time Scoring, Classification, Assortment, and Contextual Nurturing of Digital Engagements using Numerical, Statistical, and Heuristics-based Techniques

(71) Applicant: Pelatro Pte.Ltd., Singapore (SG)

(72) Inventors: Pramod Konandur Prabhakar, Banaswadi (IN); Arun Kumar Krishna, Banaswadi (IN)

(21) Appl. No.: 18/381,391

(22) Filed: Oct. 18, 2023

Related U.S. Application Data
(60) Provisional application No. 63/379,940, filed on Oct. 18, 2022.

(51) Int. Cl. G06Q 30/0201

(52) U.S. Cl. CPC G06Q 30/0201

(57) ABSTRACT

A method to for real-time scoring, classification, assortment, and contextual nurturing of digital engagements using numerical, statistical, and heuristics-based techniques. Ongoing customer engagement segregation into personas based on discovered traits and collective inferences drawn from historic and ongoing engagements, clustering ongoing engagements using numerical and string manipulation techniques. Computing real time noise and focus scores for engagements, facilitating stateless nudges for increasing favorable engagements, and providing business insights on possibly undiscovered noise and focus patterns that eventually culminate as desired or non-desired outcomes. Generating interest score for engagements based on non-linear formulations of noise and focus scores, and then clustering engagements with similar interests and focus into communities to generate additional insights and facilitate secure communication among users, efficient marketing campaigns and decisioning sales lead assignment.

### CROSS REFERENCE TO RELATED APPLICATIONS

To the full extent permitted by law, the present United States Non-Provisional Patent Application hereby claims priority to and the full benefit of, U.S. Provisional Application No. 63/379,940, filed Oct. 18, 2022, entitled “Methods for real time scoring, classification, assortment, and contextual nurturing of digital engagements using numerical, statistical, and heuristics-based techniques [Aveksha]”, which is incorporated herein by reference in its entirety.

### FIELD OF THE DISCLOSURE

The present disclosure is directed to organization of data. More specifically, the disclosure is directed to the collection and organization of real time user data to determine appropriate means and mechanisms for user interaction to facilitate increased user engagement and otherwise influence user behavior.

The present disclosure is not limited to any specific file management system, user or customer type, database structure, physical computing infrastructure, enterprise resource planning (ERP) system/software/service, or computer code language.

### BACKGROUND

Often, software service providers, financial institutions, telecommunications companies, social media services, and other user-service based businesses have a large volume of customers, users, clients, and/or subscribers. Those businesses having such large customer volumes may generally further experience voluminous interactions with those customers, which may be enormous in scale. Data related to these volumes of interactions are generally highly valuable intellectual property to the businesses, but technical challenges exist as it may relate to meaningful use of the data, either with regard to real-time user behavior or to historical behaviors, patterns, and activities. Given that marketing efforts often fall into two categories—inside sales and outside sales—these businesses often develop strategies, using this data, in order to successfully market new revenue streams and/or purchases from new and/or existing customers. Since businesses likely know more about existing customers than they do prospective customers, marketing to existing customers may more heavily rely on such knowledge to increase marketing successes across existing clientele. However, given the nature of large subscriber and/or client bases, a single individual salesperson or account manager likely does not know and/or understand motivations of all existing clients. In fact, depending on the nature of the business in relation to the clientele and the volume of clientele of the business, few, if any of the business's agents may personally know the business's user base without performing market research, user surveys, or other similar research and investigation into the clientele relationship with the business and corresponding service.

Over the years, various attempts have been made to address many technical challenges related to meaningful use of user data, each attempt with its strengths and limitations. One approach involves utilizing customer relationship management (CRM) systems to track and analyze customer interactions. While CRM systems may offer valuable insights, they may fall short in providing a holistic view of customer engagement across different channels and fail to assign optimal personas based on collective traits. Additionally, many require serious efforts by staff to investigate the overall customer profile and critical thought to determine strategies for increasing the user engagement and/or selling additional services or products. Moreover, these systems may struggle to filter out noise in engagements to discern true customer intent.

Another endeavor has focused on data analytics platforms designed to process and analyze customer data for marketing purposes. While these platforms can offer valuable insights regarding which users may be receptive to which products/services, they often face challenges in efficiently curating and stitching real-time digital interactions from diverse channels of user interactions in order to make such predictive assessments. Additionally, they may not possess the capability to identify and assign user traits nor can they assess/assign a persona for individual clients while also continuously reassessing assigned personas and intent based on evolving real-time context updates. Since it is known that clients may be more or less receptive to certain offers over time, and this receptivity may fluctuate and even peak, these data analytics platforms may often fail to properly time recommend actions or perform actions in order to induce and/or close a sale. Additionally, the frequency by which a business might interact with its customers or prospective customers to induce a sale or increase in paid-for services is often intentionally limited in order to avoid becoming an annoyance after repetitive offers and/or communications. As such, these data analytics platforms may fail to act at the ideal moment when a customer or prospective customer is most receptive to buy or increase such product/services. Accordingly, these data analytics platforms may simply advise as to who to market to, but fail to recommend when to market to those individuals.

Other solutions have attempted to leverage machine learning and AI algorithms to categorize and cluster customer engagements. While these approaches can be effective, they may still encounter difficulties in securely facilitating digital conversations between clustered cohorts, especially in collaborative engagement scenarios. Furthermore, they may not provide real-time workload and demand forecasts or support context-aware gamification programs.

Additionally, it may be generally understood that sophisticated, skeptical, or otherwise cautious or frugal users may be wary of direct solicitations from a business for new or additional products or services—even in instances where users may already be loyal customers of a business. Indirect solicitations, such as advertisements, may suffer similar skepticism and additionally may be expensive or may lack precision in certain niche markets, requiring additional wasted communications to potential users who are not in the target, possibly niche, market. However, third-party recommendations, discussions, relationships, and interactions may be generally understood to achieve significant influence over purchasing decisions. At the very least, such third-party interactions may complement direct solicitations and advertising during the marketing and sales process. While previous attempts have been made to encourage user interactions, they often fall short in creating an environment that fosters genuine and meaningful engagement. For instance, some platforms have employed automated chatbots or scripted responses, which can feel impersonal and fail to establish a genuine connection with users. Others have implemented generic prompts or surveys, which may not effectively capture the nuanced preferences and concerns of individual users. Still others may encourage development of user base discussion groups, message boards, DISCORD® servers, REDDIT® pages, FACEBOOK® groups, and other means of topic-based or brand-based group communication (collectively, online forums). Certain enthusiastic customers may even join to create their own independent online forum, and many cases may exist where such independent online forums are later sponsored by, endorsed by, supported by, or otherwise allowed by the associated brand, product, or business. By encouraging or simply allowing these online forums, brands may improve or maintain their image, which in-and-of-itself may influence customer decision-making. However, such groups may not achieve universal admiration from the online forum users and may in fact diminish the reputation via criticism. Recognizing the value of online forums and other communications between customers, many companies employ user engagement professionals to monitor, engage with, or even moderate such discussion, leading to more impactful and productive engagements. This personalized approach may not only enhance user satisfaction but may also increase the likelihood of successful conversions and long-term customer loyalty. However, such strategies may still suffer from first-party recommendation skepticism and may additionally prove costly, given the skilled labor required to monitor and engage with such online forums.

Finally, automating the assignment of leads to salespeople has been a critical pursuit for businesses aiming to optimize their sales processes. Various methods have been employed, ranging from traditional human sales teams to cutting-edge automated systems like chatbots and auto-dialing robocalls. Human sales teams, while effective, have limitations in handling large volumes of leads efficiently and such resources are often both scarce and expensive. They require time and resources for training, and their availability may be subject to constraints. While fairness in lead assignment may be relevant to certain enterprises, care can be taken to structure data related to the salesperson, to the product/service being offered, and to the individual or business being solicited. Few such systems exist which formulate discrete associations along various logical or emotional planes. Hence, many lack the nuanced understanding and adaptability of flexible approaches that consider such logical and emotional considerations in combination, potentially leading to missed opportunities, frustrated prospects, and/or disgruntled salespeople. Balancing the strengths of automated systems with the human element remains a challenge, as businesses strive for seamless and effective lead assignment processes. The present disclosure also addresses these challenges by introducing a dynamic and adaptive system that optimally assigns leads while harnessing the strengths of both human and automated approaches, and can leverage both human and digital engagements with users to achieve a standardized but flexible system capable of optimizing the appropriate sales strategy along a product or services and persona dicotomy.

Therefore, the need persists for a comprehensive system and method that efficiently collects, curates, and analyzes real-time digital interactions, assigns optimal personas, filters engagement noise, categorizes engaged entities, and enables secure digital conversations among customers and users. This disclosure addresses these challenges by providing a unified approach that encompasses all these aspects, offering a superior solution compared to prior attempts. The disclosed system and method offer a unique combination of features, including continuous reassessment of personas based on real-time context, clustering of engagements into cohorts with similar intents, and enabling context-aware gamification, which sets it apart from existing solutions discussed above. Additionally, a new approach to lead assignment and scoring thereof is disclosed. The instant disclosure may further be designed to address at least certain aspects of the problems or needs discussed above by seamlessly integrating these functionalities into a comprehensive system and method, greatly improving upon existing businesses/customer engagement strategies, systems, and methods, leading to more effective, more timely, less frequent, and more personalized interactions and thereby reducing client exhaustion/annoyance with marketing efforts in order to more efficaciously time who to market to and when.

### SUMMARY

The present disclosure may solve the aforementioned limitations of the currently available systems and methods of marketing by providing a system and method for real time scoring, classification, assortment, and contextual nurturing of digital engagements using numerical, statistical, and heuristics-based techniques. In summary, the instant disclosure may contemplate a system to accomplish this by efficiently collecting real time digital interactions over various, perhaps diverse channels, curating and stitching them to obtain a holistic interaction profile. The system may then assign the most optimal persona to individual users (or groups of users) based on collective traits discovered and filter noise in the digital interactions and other user/business engagements to determine the customer intent behind any given engagement. By assorting the engaged entities to arrive at focus of interest and continually reassessing the assigned persona and intent based on real time context updates, users may then be clustered based on these engagements into cohorts with similar intents. Having grouped users in such a manner, the system may further facilitate trusted and secure digital conversations between cohorts towards realizing a collaborative engagement experience. This may further enable the creation of context aware gamification, communication networks, and/or social networking services within the cohorts to stimulate deeper engagements among the users along common interests, thereby solidifying user trust and interaction with the business. Such increased trust and interactions can then be further studied and/or categorized in order to facilitate real time demand forecasts among the clustered cohorts and predictions for receptivity for various product lines. This may then further facilitate contextual nurturing of leads derived from the engagements towards a conversion, sale, upsell, or increased utilization.

In one aspect, the instant disclosure may address technical challenges related to real-time decisioning in marketing to customers based on user data by contemplating a system to by efficiently collecting real time digital interactions over various, perhaps diverse channels, curating and stitching them to obtain a holistic interaction profile. The system's proficiency in seamlessly integrating real-time digital interactions from a wide range of channels may establish a comprehensive view of user engagement. This level of data aggregation and synthesis enables businesses to gain deep insights into user behavior and preferences, providing a solid foundation for targeted and effective engagement strategies.

In another aspect, the system may then assign the most optimal persona to individual users (or groups of users) based on collective traits discovered and filter noise in the digital interactions and other user/business engagements to determine the customer intent behind any given engagement. Implementation of this feature may streamline communication while also providing a unique opportunity for collaborative engagement experiences. By continually reassessing personas and intent based on real-time context, the system may ensure that interactions remain dynamic, relevant and thereby persistent/consistent/continual. This adaptability may be key to maintaining high levels of user engagement over time as various interests change.

In yet another aspect, the disclosed system may cluster users based on the above engagements in order to form cohorts having similar intent(s). It may accomplish such by assorting the engaged entities to arrive at focus of interest and continually reassessing the assigned persona and intent based on real time context updates. Furthermore, by clustering users with similar intent, the system may yield a platform for meaningful collaboration and engagement among users. This innovative approach not only streamlines communication but also may foster a sense of community among users with shared interests. This collaborative engagement experience may not only strengthen user relationships with the business but also may open up new avenues for valuable insights and feedback.

In another aspect, having grouped users in such a manner, the system may further facilitate trusted and secure digital conversations between cohorts towards realizing a collaborative engagement experience. This capability to foster secure digital conversations may represent a significant advancement in facilitating user interaction. By creating a trusted environment for collaboration and secure communication among users, businesses can foster deeper connections among users. This collaborative engagement experience in a secure environment may further strengthen and solidify user relationships with the business while creating yet additional insights.

In various aspects of the above, the system and methods of the disclosure may further enable the creation of context aware gamification, communication networks, and/or social networking services within the cohorts to stimulate deeper engagements among the users along common interests. Such deep engagement may then assist to solidify user trust and interaction with the business. Such increased trust and interactions can then be further studied and/or categorized in order to facilitate real time demand forecasts among the clustered cohorts and predictions for receptivity for various product lines. The introduction of context-aware gamification, communication networks, and social networking services within cohorts may be another groundbreaking feature. This innovation goes beyond traditional engagement strategies, providing a platform for users to connect on a deeper level over shared interests to increase trust and yield further invaluable data for real-time demand forecasting and product line receptivity predictions. This level of insight may further empower businesses to make data-driven decisions with confidence.

Having assembled the above into a comprehensive system and method, further facilitation of contextual nurturing of leads derived from the engagements towards a conversion, sale, upsell, or increased utilization may be continually assessed using the systems and methods of the disclosure and/or machine learning to improve performance of subsequent contextual nurturing. The system's continuous assessment and refinement of contextual nurturing strategies may represent yet another significant leap forward in conversion optimization. By leveraging machine learning and the wealth of data collected through engagements, the system can ensure that nurturing efforts are always refined and optimized for maximum effectiveness. This iterative approach to contextual nurturing has not only been shown to boost conversion rates for businesses deploying such systems, but can also lay the foundation for sustained business growth.

Many additional features and benefits of the disclosed system and methods thereof may be appreciated by those having ordinary skill in the art. One such benefit of the present disclosure may be segregating ongoing customer engagements into different personas based on discovered traits and collective inferences drawn from historic and ongoing engagements. Indeed, cohort clustering alone according to the disclosure herein may reveal invaluable insights which alone may seriously increase a business's intelligence about its customer base. Another recognized benefit may be the system's ability to cluster ongoing engagements efficiently and effectively using numerical and string manipulation techniques on the fly, while simultaneously taking into cognizance ongoing behavioral changes in various clusters. With regard to computation of real time noise and focus scores for engagements, implementation of the disclosed system and practice of the disclosed method may facilitate personalized but stateless nudges for to induce or otherwise cause favorable engagements between and among the business and its customers in order to provide additional deep business insights on possibly undiscovered noise and focus patterns that eventually culminate as desired or non-desired outcomes. Having computed a noise and focus score, and in possession of a system for efficiently updating these scores on a per-user basis in real time, the system disclosed herein may be further capable of computing interest scores for various such engagements based on non-linear formulations of noise and focus scores, and then clustering engagements with similar interests and focus into communities, providing yet further deep business insights on such virtual communities. Given sufficient adoption of the disclosed system within a business, or adoption among complementary non-competitive businesses and/or among internal business units of the company, these fully managed digital virtual communities may additionally be offered as Application Programming Interfaces (APIs) that may be overlaid on any business-to-consumer enterprise to achieve further insights and induce further user interactions, even between such complementary businesses. The communities, both those dedicated to a single business's commercial interests or among several, may provide and facilitate such features as private chat, question and answer forums, and other discussion forums and/or communication platforms alongside user enticing features such as gratification badges and campaigning semantics which may be realized using gamification/reward marketing techniques such as racing, raffles, scratch and win, sweepstakes, charitable fundraisers, lotteries, loyalty rewards, exclusive discounts and promotions, review sample products, early access to new products/services, product customization contests, VIP event invitations, specialized workshops, personalized messages of gratitude, loyalty tiers (e.g., platinum, gold, silver, etc.), upgrade incentives, local partnerships/benefits, the like and/or combinations thereof.

The systems and methods of the disclosure may accomplish the above through a plurality of numerical, statistical, and heuristics-based techniques applied to incoming user interaction data, each of which are covered in detail below in relation to the Drawings. In summary, such techniques may include streaming ingestion of digital interactions of customers across channels, engagement-aware heuristics-based persona assignment, encoding of interactions/engagements using a symbol string, digital clustering of encoded interactions under varying noise and focus bands, machine learning from training-set interactions, cluster based/focused longest common subsequence determination/calculation, prime number weighting, real time formulations of scoring related to focus, interest, and noise using exemplary formulas as disclosed herein, and a corresponding creation of real time virtual communities for cohorts upon which certain incentive structures may be implemented to encourage engagement and increase user interest, which may be subsequently and/or continuously measured to determine success of various strategies deployed to maximize user engagement.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1A is a block diagram of a computer system of the present disclosure;

FIG. 1B is a block diagram of a communications system implemented by the computer system in FIG. 1;

FIGS. 2A-B are block diagrams of an exemplary communications systems of the disclosure;

FIG. 3 is a flow chart diagram of the user engagement encoding steps of the disclosure;

FIG. 4 is a flow chart diagram of an exemplary data organizational method of the disclosure;

FIG. 5 is a flow chart diagram of an additional exemplary data organizational method of the disclosure, including example structured user interaction schema;

FIG. 6 is a flow chart diagram that continues the example structured user interaction schema of FIG. 5;

FIGS. 7A-B are block and flow chart diagrams of exemplary noise and focus score calculations;

FIG. 7C is a flow chart diagram of an exemplary clustering process;

FIG. 8 is a flow chart diagram showing exemplary interest score calculations;

FIG. 9 is a simplified illustration of exemplary user clustering arrangements;

FIG. 10 is a block diagram of an exemplary lead assignment organizational plan; and

FIG. 11 is a flow chart diagram of an exemplary lead assignment strategy.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

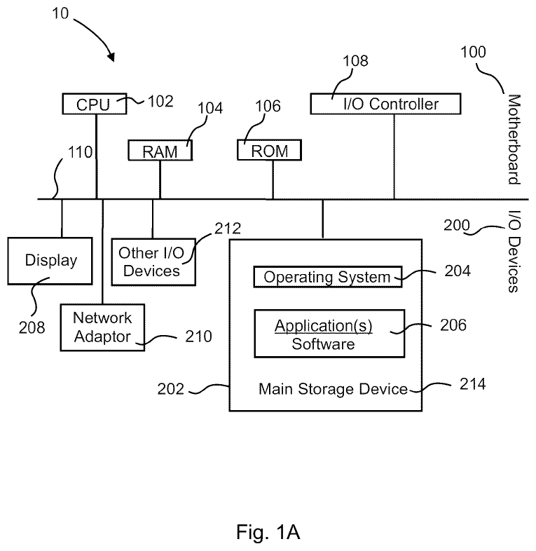

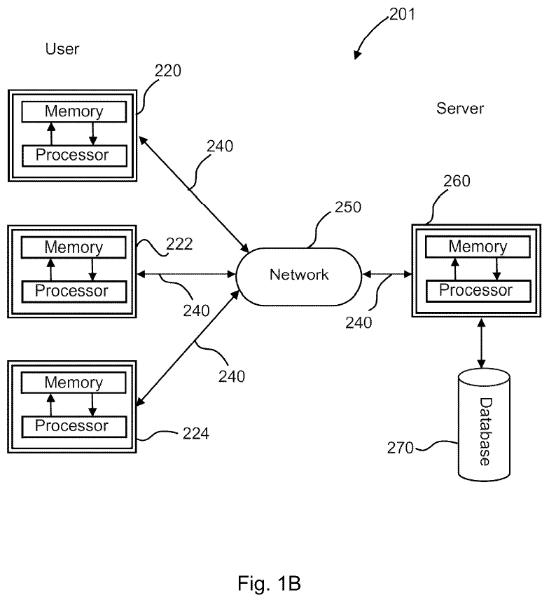

Referring now to FIGS. 1-11, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

The present disclosure solves the aforementioned limitations of the currently available devices and methods for increasing user engagement by providing a system and method for real time scoring, classification, assortment, and contextual nurturing of digital engagements using numerical, statistical, and heuristics-based techniques.

In describing the exemplary embodiments of the present disclosure, as illustrated in FIGS. 1A-1B. specific terminology is employed for the sake of clarity. The present disclosure, however, is not intended to be limited to the specific terminology so selected, and it is to be understood that each specific element includes all technical equivalents that operate in a similar manner to accomplish similar functions. The claimed invention may, however, be embodied in many different forms and should not be construed to be limited to the embodiments set forth herein. The examples set forth herein are non-limiting examples, and are merely examples among other possible examples.

As will be appreciated by one of skill in the art, the present disclosure may be embodied as a method, data processing system, software as a service (SaaS), computer program product, artificial intelligence system, machine-learning module, the like and/or combinations thereof. Accordingly, the present disclosure may take the form of an entirely hardware embodiment, entirely software embodiment or an embodiment combining software and hardware aspects in order to solve the various technical problems with the various technical solutions as may be disclosed herein. Furthermore, the present disclosure may take the form of a computer program product on a computer-readable storage medium having computer-readable program code means embodied in the medium. Any suitable computer readable medium may be utilized, including hard disks, ROM, RAM, CD-ROMs, electrical, optical, magnetic storage devices and the like.

The present disclosure is described below with reference to block and flowchart illustrations of methods, apparatus (systems) and computer program products according to embodiments of the present disclosure. It will be understood that each block or step of the flowchart illustrations, and combinations of blocks or steps in the flowchart illustrations, can be implemented by computer program instructions or operations. These exemplary computer program instructions, functions, equations, and/or operations may be loaded onto a general-purpose computer, special purpose computer, server, or other programmable data processing apparatus to produce a machine, such that the instructions or operations, which execute on the computer or other programmable data processing apparatus, create means for implementing the functions specified in the flowchart block or blocks/step or steps.

These computer program instructions or operations may also be stored in a computer-usable memory that can direct a computer or other programmable data processing apparatus to function in a particular manner, such that the instructions or operations stored in the computer-usable memory produce an article of manufacture including instruction means which implement the function specified in the flowchart block or blocks/step or steps. The computer program instructions or operations may also be loaded onto a computer or other programmable data processing apparatus (processor) to cause a series of operational steps to be performed on the computer or other programmable apparatus (processor) to produce a computer implemented process such that the instructions or operations which execute on the computer or other programmable apparatus (processor) provide steps for implementing the functions specified in the flowchart block or blocks/step or steps.

Accordingly, blocks or steps of the flowchart illustrations support combinations of means for performing the specified functions, combinations of steps for performing the specified functions, and program instruction means for performing the specified functions. It should also be understood that each block or step of the flowchart illustrations, and combinations of blocks or steps in the flowchart illustrations, can be implemented by special purpose hardware-based computer systems, which perform the specified functions or steps, or combinations of special purpose hardware and computer instructions or operations.

Computer programming for implementing the present disclosure may be written in various programming languages, database languages, the like and/or combinations thereof. However, it is understood that other source or object-oriented programming languages, and other conventional programming language may be utilized without departing from the spirit and intent of the present disclosure.

Referring now to FIG. 1A, there is illustrated a block diagram of a computing system 10 that provides a suitable environment for implementing embodiments of the present disclosure. The computer architecture shown in FIG. 1A is divided into two parts—motherboard 100 and the input/output (I/O) devices 200. Motherboard 100 preferably includes subsystems and/or processor(s) to execute instructions such as central processing unit (CPU) 102, a memory device, such as random-access memory (RAM) 104, input/output (I/O) controller 108, and a memory device such as read-only memory (ROM) 106, also known as firmware, which are interconnected by bus 110. A basic input output system (BIOS) containing the basic routines that help to transfer information between elements within the subsystems of the computer is preferably stored in ROM 106, or operably disposed in RAM 104. Computing system 10 further preferably includes I/O devices 202, such as main storage device 214 for storing operating system 294 and instructions or application program(s) 206, and display 208 for visual output, and other I/O devices 212 as appropriate. Main storage device 214 preferably is connected to CPU 102 through a main storage controller (represented as 108) connected to bus 110. Network adapter 210 allows the computer system to send and receive data through communication devices or any other network adapter capable of transmitting and receiving data over a communications link that is either a wired, optical, or wireless data pathway. It is recognized herein that central processing unit (CPU) 102 performs instructions, operations or commands stored in ROM 106 or RAM 104.

Processor 102 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1A as a single processor, in some embodiments, processor 102 comprises a plurality of processors. The plurality of processors may be embodied on a single computing device or may be distributed across a plurality of computing devices collectively configured to function as the computing device 10. The plurality of processors may be in operative communication with each other and may be collectively configured to perform one or more functionalities of the computing device 10 as described herein. In an example embodiment, processor 102 is configured to execute instructions stored in memory 104, 106 or otherwise accessible to processor 102. These instructions, when executed by processor 102, may cause the computing device 10 to perform one or more of the functionalities of the computing device 10 as described herein.

Whether configured by hardware, firmware/software methods, or by a combination thereof, processor 102 may comprise an entity capable of performing operations according to embodiments of the present invention while configured accordingly. Thus, for example, when processor 102 is embodied as an ASIC, FPGA or the like, processor 102 may comprise specifically configured hardware for conducting one or more operations described herein. As another example, when processor 102 is embodied as an executor of instructions, such as may be stored in memory 104, 106, the instructions may specifically configure processor 102 to perform one or more algorithms and operations described herein.

The plurality of memory components 104, 106 may be embodied on a single computing device 10 or distributed across a plurality of computing devices. In various embodiments, memory may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 104, 106 may be configured to store information, data, applications, instructions, or the like for enabling the computing device 10 to carry out various functions in accordance with example embodiments discussed herein. For example, in at least some embodiments, memory 104, 106 is configured to buffer input data for processing by processor 102. Additionally or alternatively, in at least some embodiments, memory 104, 106 may be configured to store program instructions for execution by processor 102. Memory 104, 106 may store information in the form of static and/or dynamic information. This stored information may be stored and/or used by the computing device 10 during the course of performing its functionalities.

Many other devices or subsystems or other I/O devices 212 may be connected in a similar manner, including but not limited to, devices such as microphone, speakers, flash drive, CD-ROM player, DVD player, printer, main storage device 214, such as hard drive, and/or modem each connected via an I/O adapter. Also, although preferred, it is not necessary for all of the devices shown in FIG. 1A to be present to practice the present disclosure, as discussed below. Furthermore, the devices and subsystems may be interconnected in different configurations from that shown in FIG. 1A, or may be based on optical or gate arrays, or some combination of these elements that is capable of responding to and executing instructions or operations. The operation of a computer system such as that shown in FIG. 1A is readily known in the art and is not discussed in further detail in this application, so as not to overcomplicate the present discussion.

In some embodiments, some or all of the functionality or steps may be performed by processor 102. In this regard, the example processes and algorithms discussed herein can be performed by at least one processor 102. For example, non-transitory computer readable storage media can be configured to store firmware, one or more application programs, and/or other software, which include instructions and other computer-readable program code portions that can be executed to control processors of the components of system 201 to implement various operations, including the examples shown above. As such, a series of computer-readable program code portions may be embodied in one or more computer program products and can be used, with a computing device, server, and/or other programmable apparatus, to produce the machine-implemented processes discussed herein.

Any such computer program instructions and/or other type of code may be loaded onto a computer, processor or other programmable apparatuses circuitry to produce a machine, such that the computer, processor or other programmable circuitry that executes the code may be the means for implementing various functions, including those described herein.

Referring now to FIG. 1B, there is illustrated a diagram depicting an exemplary system 201 in which concepts consistent with the present disclosure may be implemented or performed. Examples of each element within the communication system 201 of FIG. 1B are broadly described above with respect to FIG. 1A. In particular, the server system 260 and user system 220 have attributes similar to computer system 10 of FIG. 1A and illustrate one possible implementation of computer system 10. Communication system 201 preferably includes one or more user systems 220, 222, 224, one or more server system 260, and network 250, which could be, for example, the Internet, public network, private network or cloud. User systems 220-224 each preferably include a computer-readable medium, such as random-access memory, coupled to a processor. The processor, CPU 102, executes program instructions or operations stored in memory. Communication system 201 typically includes one or more user system 220. For example, user system 220 may include one or more general-purpose computers (e.g., personal computers), one or more special purpose computers (e.g., devices specifically programmed to communicate with each other and/or the server system 260), a workstation, a server, a device, a digital assistant or a “smart” cellular telephone or pager, a digital camera, a component, other equipment, or some combination of these elements that is capable of responding to and executing instructions or operations.

Similar to user system 220, server system 260 preferably includes a computer-readable medium, such as random-access memory, coupled to a processor. The processor executes program instructions stored in memory. Server system 260 may also include a number of additional external or internal devices, such as, without limitation, a mouse, a CD-ROM, a keyboard, a display, a storage device and other attributes similar to computer system 10 of FIG. 1A. Server system 260 may additionally include a secondary storage element, such as database 270 for storage of data and information. Server system 260, although depicted as a single computer system, may be implemented as a network of computer processors. Memory in server system 260 contains one or more executable steps, program(s), algorithm(s), or application(s) 206 (shown in FIG. 1A). For example, the server system 260 may include a web server, information server, application server, one or more general-purpose computers (e.g., personal computers), one or more special purpose computers (e.g., devices specifically programmed to communicate with each other), a workstation or other equipment, or some combination of these elements that is capable of responding to and executing instructions or operations.

System 201 is capable of delivering and exchanging data between user system 220 and a server system 260 through communications link 240 and/or network 250. Through user system 220, users can preferably communicate over network 250 with each other user system 220, 222, 224, and with other systems and devices, such as server system 260, to electronically transmit, store, manipulate, and/or otherwise use data exchanged between the user system and the server system. Communications link 240 typically includes network 250 making a direct or indirect communication between the user system 220 and the server system 260, irrespective of physical separation. Examples of a network 250 include the Internet, cloud, analog or digital wired and wireless networks, radio, television, cable, satellite, and/or any other delivery mechanism for carrying and/or transmitting data or other information, such as to electronically transmit, store, manipulate, and/or otherwise modify data exchanged between the user system and the server system. The communications link 240 may include, for example, a wired, wireless, cable, optical or satellite communication system or another pathway. It is contemplated herein that RAM 104, main storage device 214, and database 270 may be referred to herein as storage device(s) or memory device(s).

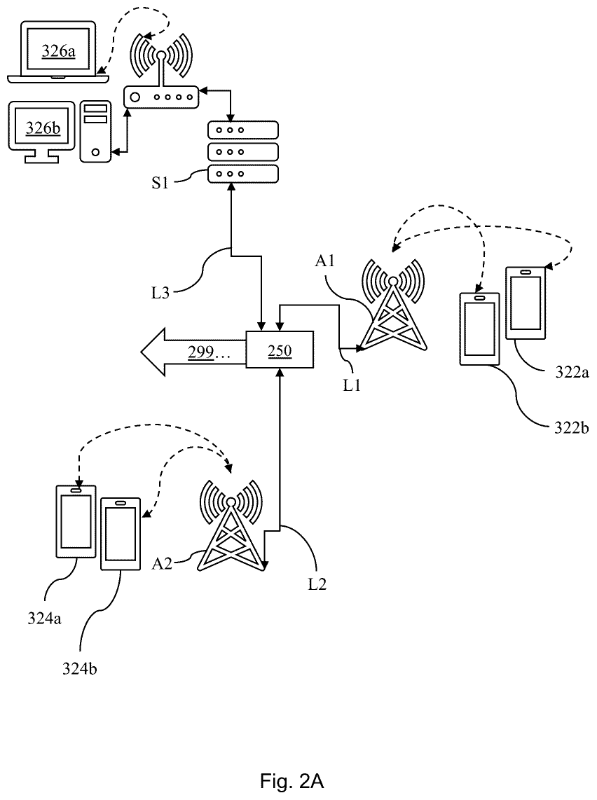

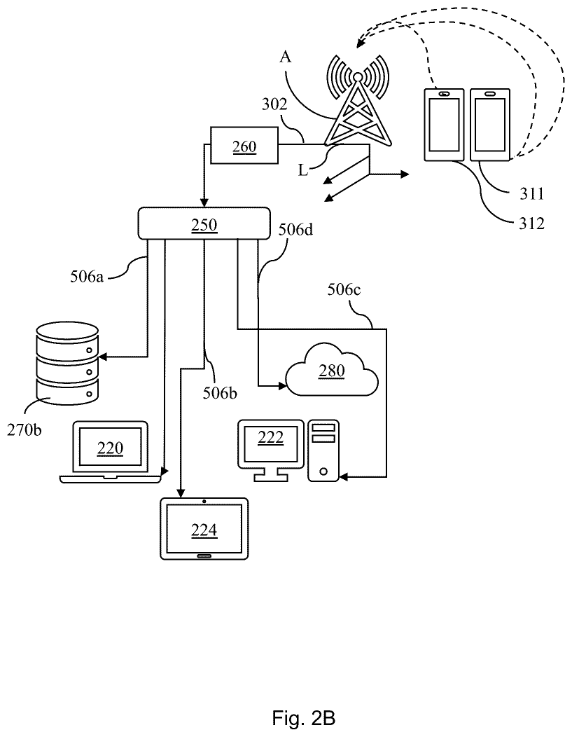

Referring now specifically to FIG. 2A, illustrated therein is a block diagrams of an exemplary communications systems of the disclosure. By way of example, and not limitation, these may include various handsets and user computing devices within a telecom network, simplified to include only very few users to better illustrate and describe the activities thereof. Starting at the righthand side of FIG. 2A, subscriber devices 322a, 322b may be closest to or otherwise coordinated to receive and transmit data wirelessly to and from antenna A1. Clockwise, subscriber devices 324a, 324b may be closest to or otherwise coordinated to receive and transmit data wirelessly to and from antenna A2. Finally, subscriber devices 326a, 326b may be closest to or otherwise coordinated to receive and transmit data wirelessly or via a wire to and from network server S1. As may be noted and observed by those skilled in the art of telecommunications and network infrastructure design and implementation, each of subscriber devices 322a-b, 324a-b, and 326a-b are representative only and may in fact represent hundreds, thousands, or millions of subscriber devices, each connected to various antennas and networks throughout a mobile and fixed telecommunications infrastructure. From each of antenna A1, antenna A2, and server S1 may be telecommunications lines L1, L2, and L3, respectively, which may reach telecom computing machine 360 for receipt and intake/storage/processing by the company using its human and machine infrastructure or other entities having access to such data through its ordinary operation and transmission through such networks. Also clear to those having ordinary skill in the art, such telecom computing machine 360 may represent one machine or, more likely, many machines at one or more locations. Furthermore, such a telecom computing machine 360 may be implemented in a cloud computing or distributive environment. Subsequent to receipt, data from each subscriber may arrive simultaneously or in quick succession as incoming data stream 299.

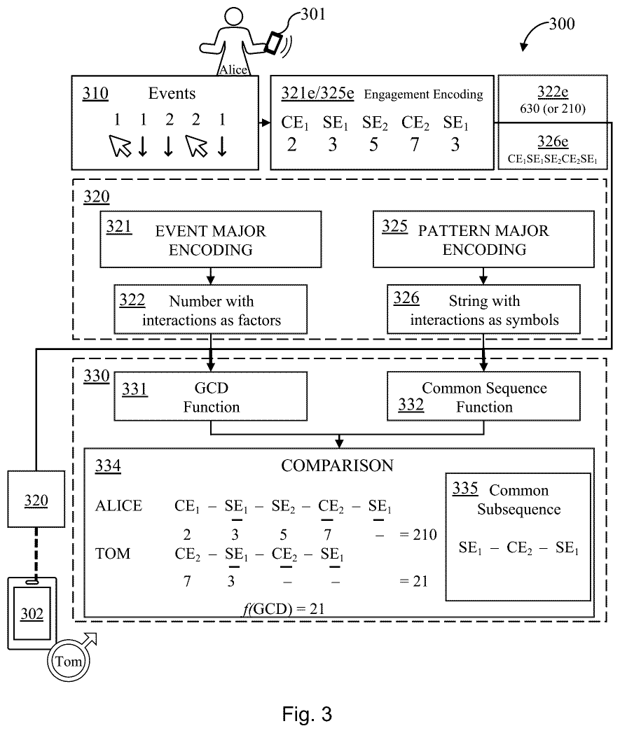

Then, with respect to FIG. 2B, therein illustrated is a block chart having a flow diagram of an exemplary intake ingestion scheme in the exemplary telecommunication network and computerized services infrastructure, described in a basic exemplary embodiment in FIG. 2A. Basic components, which may or may not be required depending on the users/systems/subscribers/customers/content being monitored, studied, or stored, are exemplary only. A system and method according to the disclosure may be and likely is more complicated than may be illustrated in FIGS. 1A, 1B, 2A, and herein, and may involve multiple (or numerous) towers, user devices, networks, servers, users, the like, and/or combinations thereof as may be understood by those having ordinary skill in the art. Beginning with various subscriber/user interaction(s) with various telecommunications and other computerized services infrastructure, first subscriber device 311 and second subscriber device 312 may each interact with antenna A, which may in turn transmit data and/or communicate via telecommunication line L with, for example, server system 260 and other devices on network 250, which may include exemplary database 270b, user systems 220, 222, 224, and virtual machine 280 via, e.g., network lines 506a-d. Obviously, a high volume system, such as those designed to benefit from the disclosed system and method for real time distributed adaptive cube aggregation, heuristics based hierarchical clustering and anomaly detection framework for high volume streaming datasets may be much more complicated than the elementary network examples provided herein, and may feature many hundreds or even millions of such exemplary devices as illustrated herein, and be connected via means known by those having ordinary skill in the art. The above communications and computerized services environment, at least with respect to the disclosed system and method for real time scoring, classification, assortment, and contextual nurturing of digital engagements using numerical, statistical, and heuristics-based techniques, its features and benefits, and potential implementations may be even better understood by those having skill in the art from a review of the remaining FIGS. 3-11, in addition to the accompanying Detailed Description.

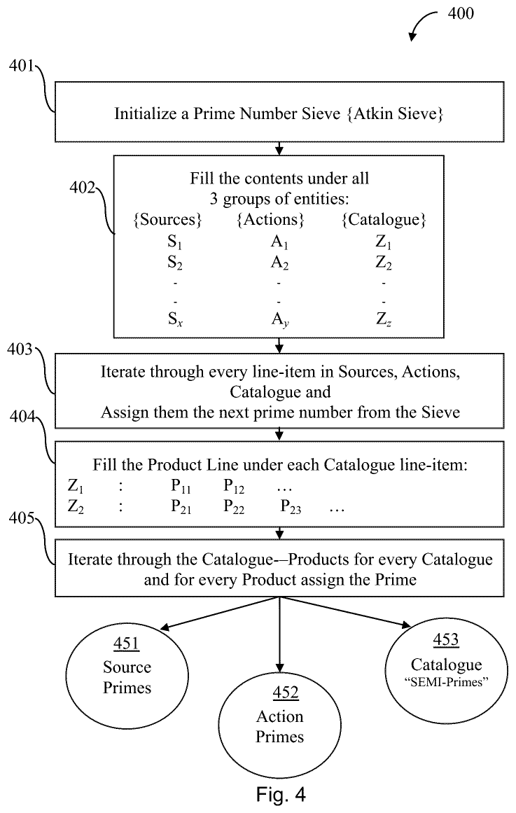

Referring now specifically to FIG. 3, therein illustrated is a flow chart diagram of user engagement encoding steps 300 of the disclosure. As may be appreciated by those having ordinary skill in the art, FIG. 3 is also a simplified arrangement showing only limited user interactions and engagements with such communications and user services platforms. These environments may in fact be much larger in reality and may feature hundreds, thousands, millions, billions or more users, engagements, and other interactions of the disclosure. Starting at the users of focus, Alice and Tom, each user may have in their possession and operation user handsets 301-302. As illustrated therein, FIG. 3, Alice is in possession and operation of user handset 301 and Tom is in possession and operation of user handset 302, though such operations and interactions may be performed on other computing devices of network 250. Focusing on Alice's engagement with a service provided by a company via network 250, a recording of example events 310 may be obtained by a company via incoming data stream 299, and begins user engagement coding and comparison steps 300. Such streaming ingestion from incoming data stream 299 may generally occur in real time with respect to user handset 301-302 and their activities and interactions with the company's digital services and may occur across different channels. Example events 310 may represent Alice's engagement with the enterprise in her five discrete actions performed on user handset 301, which may include two clicks, represented by cursors, and three scrolls, represented by down arrows, on, for example a mobile application provided by the company or enterprise in order to offer, sell, or otherwise furnish its digital services to Alice. The numbers as indicated in example events 310 may indicate each of two discrete product/services offerings of the company that can be obtained, viewed, or otherwise inquired about using an enterprise's mobile application. However, the disclosure is neither limited to mobile devices nor mobile applications. As illustrated therein example user engagement digitization 321e, “C” may then indicate clicking and “S” may indicate scrolling and may have occurred in time order from left-to-right across a short period of time. “E” as illustrated therein and its corresponding subscript may indicate the product or services offering from the enterprise featured within its mobile application or web interface. Together, the leading letter and following subscripted letter may form a symbol. Hence, as may be appreciated by those having ordinary skill in the art, example events 310 may be thought of as a series of events/interactions of user handset 301 on network 250 obtained via incoming data stream 299 and assembled into a memorialized engagement therein example user engagement digitizations 321e, 325e to, for instance determine a pattern. Then, each discrete combination of letters and/or symbols may be assigned a prime number as indicated below each interaction shown therein example user engagement digitizations 321e, 325e, CE₁ may represent a first interaction, which may be and is indicated therein example events 310 as a click upon a first product or services offering of the enterprise on user handset 301, SE₁ may represent a scroll passed the same offering, SE₂ may represent a second scroll passed a second offering, CE₂ may represent a click on that offering, and SE₁ may again represent the second action/event which may have been a scroll passed that second offering. Hence, since a first interaction of user handset 301 with the application via network 250 by, perhaps any user ever, such interaction of CE₁, that is clicking on the first product/services offering of the enterprise, it may be assigned a first exemplary prime number, which for purposes which may be further understood by those having skill in the art through a review of the below, may be “2”. Since the second interaction is discrete from the first, it may be represented by the next prime number in order, or “3”, and so on. Concluding with the repeated step, which may have been SE₁, “3” is repeated in sequence as indicated therein example user engagement digitizations 321e, 325e. Having digitized the engagement from discrete actions into a series of prime numbers, further example encoding steps 322e, 326e may be performed upon the product of example user engagement digitizations 321e, 325e as specified therein FIG. 3. Such steps may occur sequentially and/or simultaneously and may include, for example, first generating a “multi-prime” number or prime number product by simply multiplying the prime numbers of example user engagement digitizations 321e to form such a product of prime numbers at example number-ization 322e, yielding 630 (or 210 if repeated interactions are not weighted during multiplication) in this example. Then, before, or simultaneously, example stringing 326e may occur to lay in order the letters/symbols of example user engagement digitizations 325e as provided. Those having ordinary skill in the art may appreciate such calculations may be performed across all users on the network, Alice representing one user, and may include the illustrated steps of event major encoding 321 followed by generating a product the numbers obtained from event major encoding 321 at number-ization step 322 which may occur before, after or simultaneously with pattern major encoding 325 followed by stringing step 326, according to this example, and may overall form encoding and recording process 320. Then, events of users may be memorialized and updated to be represented by a series of symbols in a string and a prime number product, each being useful for comparison stage 330, which may be performed upon 2 or more users (i.e., billions) of the enterprise's product/services offerings. Comparison stage 330, as may be appreciated by those having ordinary skill in the art, may comprise very simple and well-known mathematical functions: GCD function 331 and Common Sequence Function 332. One having skill in the art may recognize the prime number product from number-ization step 322 will mean that any two users having performed the same discrete action (e.g., clicking on product 2) will share in their record the associated prime number, making that prime number one or more of the factors of the greatest common denominator when GCD function 331 is performed. This prime number, however, does not include, does not preserve data related to, and/or ignores the order in which operations/activities are performed. Hence, in the examples provided related to Alice and Tom's user interactions with their respective user handsets 301, 302, GCD function 331 may yield 21, which can be factorized into 3×7, corresponding to SE1 and CE2, meaning that both Alice and Tom have at one point in the session(s) being compared have scrolled passed product/services offering 1 and clicked on product/services offering 2. By performing the Common Sequence Function, it can further be revealed that each user has scrolled passed 1, then clicked on 2, then scrolled passed 1 again. Note that intervening step of scrolling passed 2 by Alice may optionally be ignored such that common subsequences are determined more broadly. Such an organizational schema and performance of functions may be better appreciated by a person having ordinary skill in the art, at least with respect to the disclosed system and method for real time scoring, classification, assortment, and contextual nurturing of digital engagements using numerical, statistical, and heuristics-based techniques, its features and benefits, and potential implementations by reviewing the remaining FIGS. 4-11, in addition to the accompanying Detailed Description.

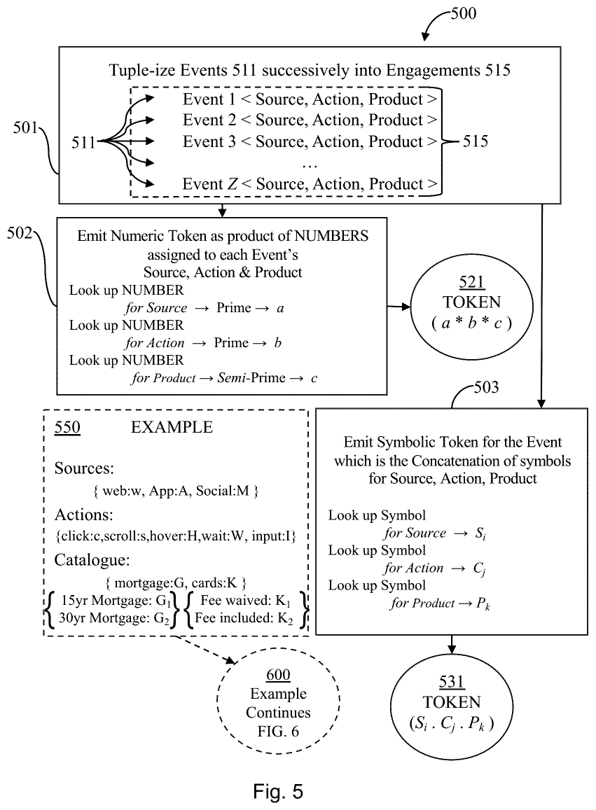

Referring now specifically to FIG. 4, therein illustrated is a flow chart diagram of exemplary data organizational method 400 of the disclosure as it may relate to the system and method for real time scoring, classification, assortment, and contextual nurturing of digital engagements using numerical, statistical, and heuristics-based techniques of the disclosure. Overall, exemplary data organizational method 400 may be further important to the assignment of prime numbers as such may relate to user engagement encoding steps 300. Beginning at step 401, a prime number sieve may be initialized, or an Atkin Sieve (or Sieve of Atkin) as may be known to those having ordinary skill in the art, which may be a modern algorithm for finding all prime numbers up to a specified integer, which may be very large. Compared with the ancient sieve of Eratosthenes, which marks off multiples of primes, the sieve of Atkin does some preliminary work and then marks off multiples of squares of primes, thus achieving a better theoretical asymptotic complexity. In possession of such a sieve, the contents under the exemplary entity groups of Sources, Actions, and Catalogues may be filled at step 402 as illustrated therein, or alternatively, such step may occur in advance, simultaneously with step 401. Having both a prime number sieve initialized at step 401 and having filled each entity group at step 402, step 403 may then iterate through every line-item in each entity group in step 402 and assign each a prime number from the sieve obtained at step 401 and then fill the product line under each catalogue line item Z, as illustrated therein step 404. Importantly, with regard to step 403, an approach may be taken using (x+y+z) primes and/or storage of the same as individual prime factors in a string in order to identify events like clicking and other actions in isolation, rather than in conjunction with other events not chosen, and other activities may be chosen based on certain business considerations in order to study and act upon such other activities. Additionally, an alternative approach may be taken based on these business considerations where an (x*y*z) function is instead performed at step 403 in order to instead store a prime number product, in which case the prime number sieve initialized/obtained at step 401 may be useful to the systems of the disclosure to later obtain and/or sustain the data preserved therein through mere factorization of the resulting prime number product. In real-world contexts, where for instance dozens of sources may be monitored, tens of actions may be further monitored, and hundreds of products/services (or product types/service types) may yet still further be monitored using the techniques disclosed herein (across thousands, millions and even billions of users), such initialization and continued use of such a sieve may greatly improve the speed and efficiency by which data can be obtained, processed, reviewed, investigated, observed, or otherwise used. Then, in every product-catalogue may be assigned a prime number from the sieve obtained at step 401 according to the function {P(Zᵢ)×(next prime in sieve)} where P(Zᵢ) represents every catalogue-product in step 404 at step 405, thereby obtaining all source primes 451, all action primes 452, and “SEMI-Primes” catalogue 453 (i.e., the product of each Z, and assigned prime from Step 405, concluding with output of all source primes 451, all action primes 452, and “SEMI-Primes” catalogue 453. Such a digital scheme may be understood by those having ordinary skill in the art to result in every number of source and action set getting assigned a prime number and every product in the catalogue being assigned a semi-prime number, which is the product of a prime number and Zᵢ according to the corresponding catalogue. This may be better appreciated by a person having ordinary skill in the art, at least with respect to the disclosed system and method for real time scoring, classification, assortment, and contextual nurturing of digital engagements using numerical, statistical, and heuristics-based techniques, its features and benefits, and potential implementations by reviewing the remaining FIGS. 5-11, in addition to the accompanying Detailed Description.

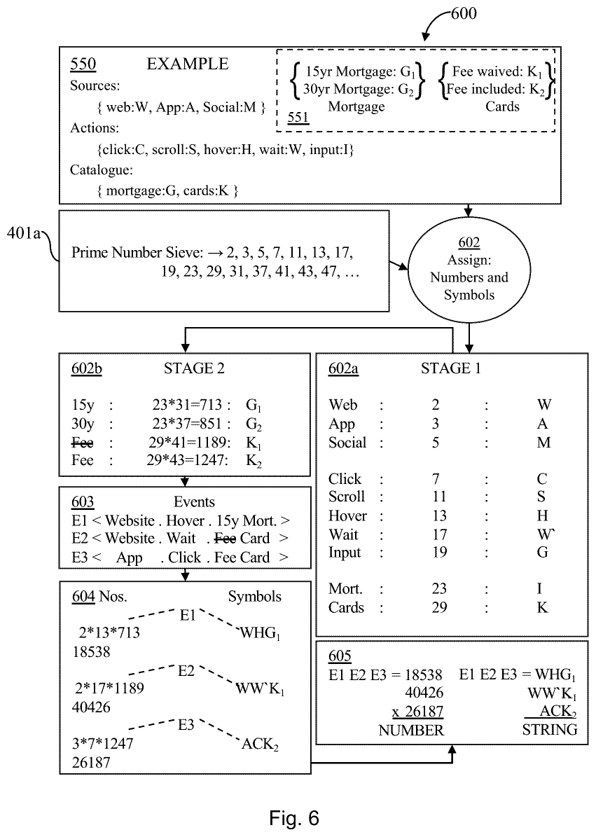

Referring now specifically to FIG. 5, therein illustrated is a flow chart diagram of an additional exemplary data organizational method 500 of the disclosure, including example structured user interaction schema. Beginning at step 501, an event, which may be the combination of a source, action, and product in some embodiments, though other objects of study may be identified for use with this schema, is recorded or otherwise formatted into a tuple, illustrated as tuples 511 in engagement schema 515. At step 502, numeric token 521 may be emitted as a product of numbers, which may be assigned to each event's source, action, and product by using lookup functions for each, according to the prime and semi-prime arrangement disclosed in relation to FIG. 4. The examples of a, b, and c may each then be a prime number forming numeric token 521 of (a×b×c) as indicated therein FIG. 5. Then symbolic token 531 may be emitted at step 503 using similar lookup functions on sources, actions, and products, which may have been indicated as symbols according to the processes/features as disclosed therein FIG. 3. Turning to example schema 550, sources are indicated as web (W), app (A), and social media (M), actions are indicated as clicks (C), scrolls (S), hovering (H), waiting (W′), and inputting (I), and the catalogue may include mortgage (G) and cards (K), which may have corresponding products of 15-year mortgages (G₁), 30-year mortgages (G₂), waived fee cards (K₁) and cards having fees (K₂). As may be understood by those having ordinary skill in the art, clicks may mean a click on any app button, hyperlink, or other user-clicking target which may be capable of being perceived by a digital services system, scrolls may mean any user action which bypasses or otherwise obscures from GUI view (e.g., moving down a web browser page) a particular version of the same, hovering may mean a user action having a delay which can be particularized to the same, waiting may mean an absence of user action for a period of time (e.g., 5 seconds, 10 seconds, etc.), and inputting may mean the user input of information and/or selection of a data by a user on a user device. As should be understood by those skilled artisans, many user actions may be both capable of perception of the digital services enterprise and are intended to be covered by the disclosure herein. Accordingly, products/services within mentioned above are non-exhaustive and include any product/service which may be offered by an enterprise. Systems and methods of tokenization of these sources, actions, and products can then be further understood from a review of FIG. 6 of example tokenization 600.

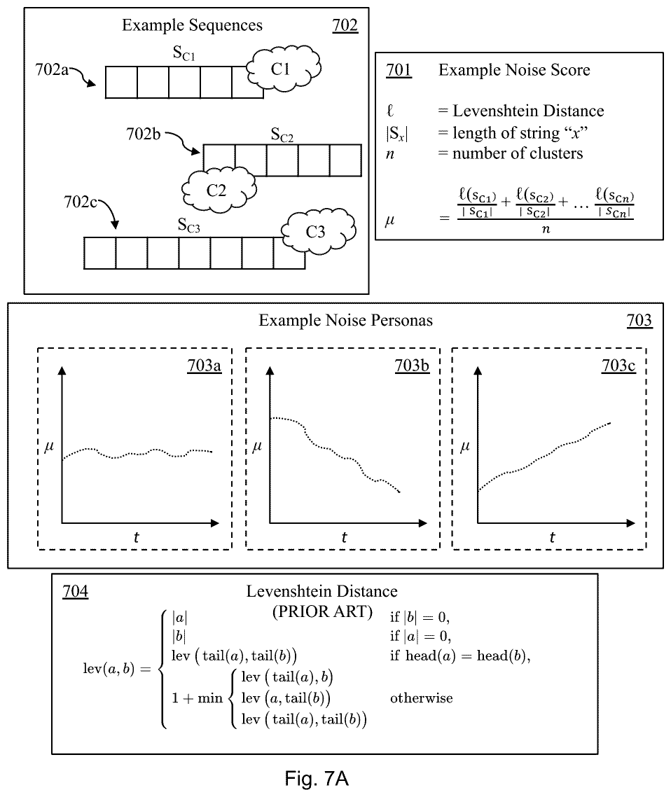

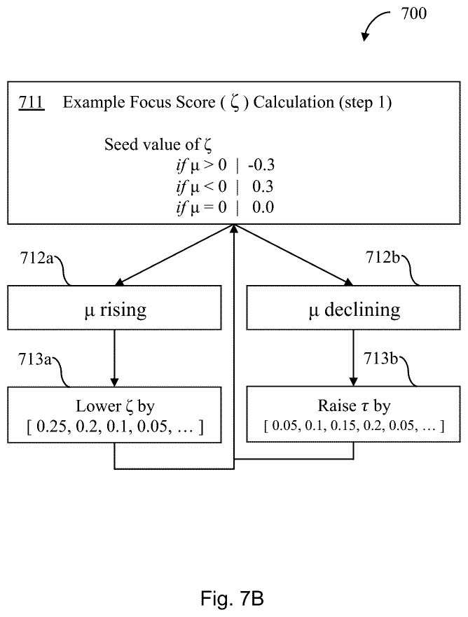

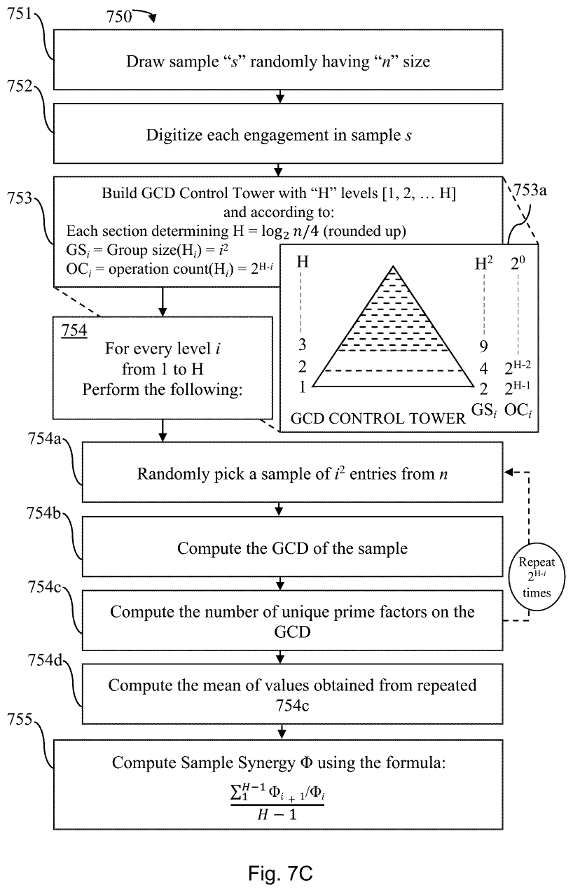

Referring now specifically to FIG. 6, therein illustrated is a flow chart diagram that continues the example structured user interaction schema of FIG. 5 as example tokenization 600. Starting at example schema 550, sources are indicated as web (W), app (A), and social media (M), actions are indicated as clicks (C), scrolls (S), hovering (H), waiting (W′), and inputting (I), and the catalogue may include mortgage (G) and cards (K), which may have corresponding products of 15-year mortgages (G₁), 30-year mortgages (G₂), waived fee cards (K₁) and cards having fees (K₂) as illustrated in FIG. 5, with the product catalogue split as indicated by catalogue schema 551. At step 602, numbers and symbols are assigned according to prime number sieve 401a more thoroughly described in relation to FIG. 4 (step 401). Then, numbers and symbols can be observed at stage 1 box 602a. Stage 2 box 602b then includes formation of product-catalogue product by multiplying the prime assigned in Stage 1 box 602a to each catalogue (product category) with yet another prime number, which may be unique to each product. Successive events may then be tuple-ized in step 603 according to the example provided therein. Numbers are formed, which are products of each event tuple and symbols are stringed also according to each tuple at step 604, which can be successively multiplied and/or stringed at step 605, in order to finalize example tokenization 600. Such example tokenization 600 may be then better appreciated by a person having ordinary skill in the art, at least with respect to the disclosed system and method for real time scoring, classification, assortment, and contextual nurturing of digital engagements using numerical, statistical, and heuristics-based techniques, its features and benefits, and potential implementations by reviewing the remaining FIGS. 7-11, in addition to the accompanying Detailed Description.

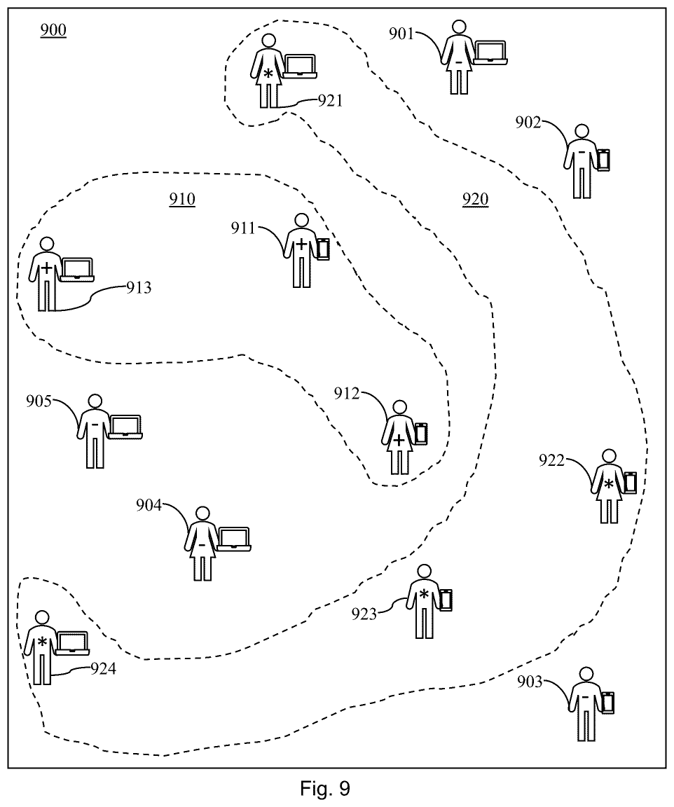

Referring now specifically to FIGS. 7A, therein illustrated are block diagrams of exemplary sequences 702, exemplary noise score calculation 701, and example noise personas 703 (703a-c). Starting at exemplary sequences 702, various events as herein described may be obtained via incoming data stream 299 (which may be understood herein and referenced as a continuous user activity data stream, a continuous user activity stream, or simply stream) and tokenized using the procedures, calculations, and other methods as disclosed above. Accordingly, session 702a, session 702b, and session 702c are illustrated to include 5, 5, and 7 events. Then, using exemplary noise score calculation 701, a Levenshtein Distance first may be obtained. A Levenshtein Distance, as may be understood by those having ordinary skill in the art of information theory, linguistics, and/or computer science, is a string metric for measuring the difference between two sequences. Informally, the Levenshtein Distance between two words (or strings) is the minimum number of single-character edits (insertions, deletions or substitutions) required to change one word into the other. Strings for calculating such Levenshtein Distance may be obtained using the techniques described above and Levenshtein Distance formula 704 has been provided for reference. As illustrated therein Levenshtein Distance formula 704, the Levenshtein distance between two strings a,b (of length |a| and |b|, respectively) is given by lev(a,b) where the tail of some string x is a string of all but the first character of x, and head(x) is the first character of x. Either the notation x[n] or xn is used to refer the n^{th} character of the string x, counting from 0, thus head(x) =x₀=x[0]. Levenshtein Distance may be further understood as the number of single digit/character alterations in the form of inserts, modifications, or deletions required to change one string to other forms. Once such calculations have been performed and turning back to exemplary noise score calculation 701, Sₓ may be obtained as the length of any string, or sequence of events organized by the techniques as disclosed herein. Then the number of clusters n may be obtained using formulations covered in relation to FIG. 9. Arriving at one exemplary formula, a noise score which can be computed continuously as a function of a particular engagement's proximity with all such clusters at any point in time using the function:

$$μ = \frac{\frac{l ( {S}_{C 1} )}{\vert {S}_{C 1} \vert} + \frac{l ( {S}_{C 2} )}{\vert {S}_{C 2} \vert} + … \frac{l ( {S}_{Cn} )}{\vert {S}_{Cn} \vert}}{n} ,$$

where μ is the noise score and l(Scₓ) representes performing such Levenshtein distance function upon any given resulting string “S” of a cluster cₓ, or others means for performing such evaluation of such user data as may be known to those having ordinary skill in the art. In fact, any formula which may score those engagements that have maximum divergence from every cluster, as herein described, is considered to have high noise, while any engagements with interactions that are familiar or mapped to other clusters, as may be described herein, are calculated to have low noise scores may be used in order to calculate a noise score which may be used in the formulation of other calculations as herein disclosed. As may be further relevant to the disclosure as herein illustrated in FIG. 7A and above description, “Sₓ” may denote the string equivalent of the sequence for any cluster x. Those having ordinary skill in the art may recognize that by using such data organizational and encoding methods, users of the disclosed system may be more readily enabled to compute the arithmetic mean of the ratio of the Levenshteins distance between the digitized engagement coded as a string and the string encoding of the cluster versus a length of the string encoding of the cluster (where such length may be further indicated by |Sₓ|). While the disclosure provides one such technique of stringing user encounters, events, and engagements into clusters, those skilled in the art may know of other comparable such methods to obtain such use-relevant data and processes thereof to obtain a clustered user arrangement. As such, example noise score personas 703a-c are provided, wherein such personas may be uniform in nature (see step 703a), may indicate positively trending in concentration (see step 703b), or may be negatively trending in concentration (see step 703c). Such personas may further be used in the formulation of other calculations and/or decisioning as herein disclosed.

Referring now specifically to FIGS. 7B, therein illustrated is a flow chart diagram of exemplary focus score calculation method 700. Such calculation may generally rely on the techniques as described above. Focus score may be indicated herein “ζ”. First, focus score may be seeded at step 711 by first calculating μ, and determining whether it is positively or negatively trending. If positive, a −0.3 value may be indicated, if negative, a 0.3 value may be indicated, and if it is 0, a 0 value may be indicated. Having seeded these values, μ may be monitored for positive trending 712a or negative trending 712b, where noise is either increasing or decreasing, respectively. If positively trending 712a (i.e., noise is increasing), focus score may be iterated downward 713a (i.e., incremented downward) by an amount chosen by a chosen amount and if negatively trending (i.e., noise is decreasing) it may be iterated upward 713b (i.e., incremented downward) by a chosen amount. Then, the process may repeat with each successive event and/or engagement sequence. It should be noted that according to the example provided in exemplary focus score calculation method 700, that each successive positive or negative μ trend may increase or decrease the amount of increase or decrease performed upon focus score, and such an increase/decrease may cap at, e.g., 0.05, and the numbers listed therein 713a-b are provided as exemplary increments only.

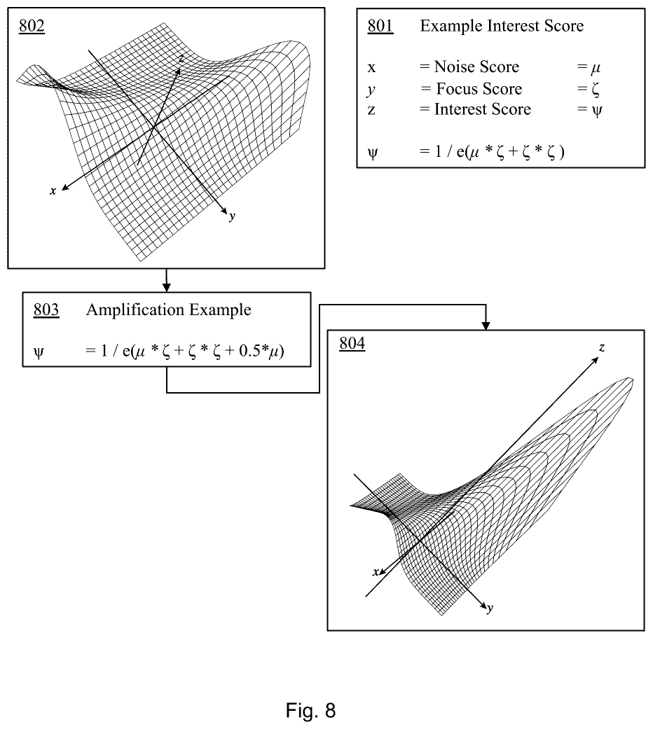

With regard to FIGS. 7A-B, certain terms may be understood by those having ordinary skill in the art. These may include noise, which may mean lack of parity or similarity in terms of an individuals activity and engagement with certain cohorts as may be described in relation to FIG. 9. Focus may refer to parity or consistency of an individuals activity and engagement in relation to recent and/or past, which may be continuously relevant to the adjustment-'recalculation thereof the corresponding focus score. Both noise and focus may factor into the calculation of the interest score, and in general, noise may be understood to negatively impact interest and focus may be understood to positively impact interest. By leveraging fundamental mathematical formulas, such as greatest common denominator and prime factorization for noise score calculation and string operations like common subsequence and Levenshtein Distance for focus score determination, system resources may be optimally leveraged across very large subscriber populations. Having a heuristics approach for its knowledge building, this data simplification may yield surprising results and observations which may be important to be discovered in order to increase certain business success and formation of clusters of user groupings. Such decisioning may be automated, studied, and reasoning behind certain decisioning and/or clustering may be later determined via investigative resources to determine yet other decisioning and clustering. Having calculated noise score and focus score, according to the techniques as described herein, interest score may be obtained, according to the disclosure as it relates to FIG. 8.

Referring now specifically to FIG. 7C, therein illustrated is a flow chart diagram showing exemplary clustering and cluster discovery processing steps 750. Clustering may be achieved through exemplary clustering and cluster discovery processing steps 750, which may or may not need to be performed in order. Where “s” denotes a randomly drawn sample consisting of, for instance at least 1% of an organization's users, or alternatively a percentage of a sub population of users, such a randomly drawn population or subpopulation s may be sized “n”, where n equals the size of such population at step 751. Importantly, the overall size n when increased may in fact increase the overall quality of the performance of such a clustering scheme, so those having ordinary skill in the art may optimally choose a large or larger sample size in certain populations or sub populations having fewer than, for instance fewer than 100,000 users at step 751. Engagements are then digitized/encoded at step 752 for each engagement in sample s, which may be occur according to the processes and techniques disclosed herein, yielding the composite numbers, which may often be large (e.g., 20+ digits in base 10). Then at step 753, a greatest common denominator “control tower” (GCD Control Tower 753a) can be built with “H” levels from [1, 2, . . . H] and each session determining H may be determined according to the formula H=log₂ b/4 (which may yield a fraction or other non-whole number which may be rounded up to the next highest integer) as illustrated therein step 753, wherein each level from 1 to H is i and each group size for each level has a group size of i², where there may exist an exception for a group at level 1, which may instead have a size of 2 (which is i²+1). Further explaining step 753, an operation count for each level may be calculated by 2^{H-i}. At step 754, for every level i, the following substeps 754a-d may proceed. First, at step 754a, a random subsample of i² entries from the sample are selected and a greatest common denominator of the subsample may be obtained at substep 754b, the GCD thus obtained may in turn be factorized to primes using well-known prime factorization techniques and the count of unique prime factors in the GCD obtained at substep 754c. Substeps 754a-c may then repeat, for example 2^{H-i} times, and a mean may be calculated which is the average of mean values obtained from all repeated unique prime factor counts obtained at substep 754c, to conclude step 754 at substep 754d. This value obtained at 754d, as may be indicated herein, may represent a synergy and/or synergy score at level i, which may be denoted herein and at FIG. 7C as Φᵢ. Then, a sample “s” synergy score (Φ) may be obtained at step 755 according to the formula

$$\frac{{\sum }_{1}^{H - 1} Φ i + 1 / {Φ}_{i}}{H - 1} ,$$

as illustrated therein step 755. Then, in order to discover clusters, a series of additional steps may be performed on the total user population and/or subpopulation. This series of steps may first include determining the appropriate number of clusters (cₙ), which may be recommended by the systems and methods of the disclosure as the cubic root of all users in the digital services platform or a subpopulation thereof. Then, for each level i as described above in GCD Control Tower 753a, the synergy score Φ may be obtained according to the above and the results thereof may be sorted in decreasing order of synergy. Then, the top clusters may be selected in accordance with the appropriate number of clusters as having the most attributes in common. For every cluster, which may represent 1% of the cluster base which may be chosen at random, the greatest common denominator (and factorization thereof) and common sequence from the sequence string of the cluster (or shortest common subsequence) may reveal further commonalities among each cluster and users within the clusters may be connected using the additional features, operations, procedures, and systems as disclosed below. As may be understood by those having skill in the art, the string sequences assigned to the various clusters denoted by SC₁, SC₂, etc. as they appear therein FIG. 7A may further represent such string sequences as may be obtained via the performance of the steps 750 as may be disclosed herein FIG. 7C. Accordingly, as has been stated throughout the description herein, many of the processes and techniques as disclosed herein may be performed asynchronously, at least with respect to the order in which they appear in the disclosure, as may be understood by such skilled artisans. As may be further understood by those having ordinary skill in the art, with respect to the prime factorization performed at substep 754c, any algorithm by which a prime factorization of a number may proceed may service such a function and may be substituted herein. With respect to a non-limiting example of such a prime factorization algorithm, the Fermat's factorization method may be used to complete substep 754c or others may be substituted to achieve similar results.

Referring now specifically to FIG. 8, therein illustrated is a flow chart diagram showing exemplary interest score (ψ) formula 801 and amplification steps 803-804. In possession of noise score μ and focus score ζ, according to the procedures identified above, ψ=1/e (μ*ζ+ζ*ζ) (where “e” as defined herein is Euler's Number (˜2.71828) as may be understood to those having ordinary skill in the art, though other substitute values and/or mathematical formulae may be otherwise known to those having ordinary skill in the art) may yield an interest score, which may be graphed in three dimensions where x=μ, y=ζ and z=ψ at chart 802. Amplification can then proceed to occur via the formula ψ=1/e(μ*ζ+ζ*ζ+0.5*μ) at step 803, yielding chart 804. Such functions plotted accordingly may reveal that interest scores are high when noise is low and focus is high, while interest score may still be considered high when there is considerable noise and low focus. A perhaps important and/or salient feature of the disclosure may be an interpretation that when noise may be high and focus may be low, a user may be perhaps exploring something keenly but is only unsure of what he or she wants. By performing amplification step 803, according to the example therein chart 804, focus score may be viewed as the key to greater weight placed on perceived interests, but noise as a deterrent dent in the interest score. While a negative noise score may be considered necessary to a high interest score, once an interest materializes, the level of negative noise may not be very significant. While interest, noise, and focus scores may be applicable to all products, it may additionally be studied only in relation to specific products, product catalogues, or services provided by the enterprise. Such interest scores based on particular products and/or engagements with the services overall may then be used in the clustering process as may be disclosed herein.

Referring now specifically to FIG. 9, therein illustrated is a simplified illustration of exemplary user clustering arrangements in example computing environment 900 as may be formed via the processing disclosed herein. Clustering of users, based upon common interests that may be deduced according to the features described above, may be formed (see FIG. 7C). Assuming a product and/or service being studied, those users may be determined to have significant interest in one product, negative interest in others, or may separately have other interests in another. Further assuming those individuals 901-905 labeled with (−) have negative interest in a product, those individuals 911-913 labeled with (+) may have positive interest in a product, and yet other individuals 921-924 labeled with (*) may have positive interest in another product. Hence, individuals 911-913 may be clustered and then assigned into +interactive channel 910 and individuals 921-924 may be clustered and then assigned into * interactive channel 920. Such interactive channels 910, 920 may be digital communities formed by the enterprise or agents thereof and may include certain Q&A forums, chatrooms, or other digital communication means, which may be secure and/or private to those individuals. Such interactive channels 910, 920 may involve invitation, credentials, induction, membership, and revocation, which may be performed automatically when interest score raises to a threshold level or decreases below that or another threshold level. As interest scores are calculated using multiple dimensions with noise filtering, and since interactive channels 910, 920 are clustered along a point in time, such resulting cohorts may then have a chance to interact with one another to clarify their firsthand queries from other verified users sharing interests, thereby solving technical challenges related to segregation of clientele by interests, given a plurality of product/services offerings. Further uses of such digital transformation of digital interactions may further resolve other technical challenges as they relate to the automatic and/or computer-advised lead assignment, as discussed below.

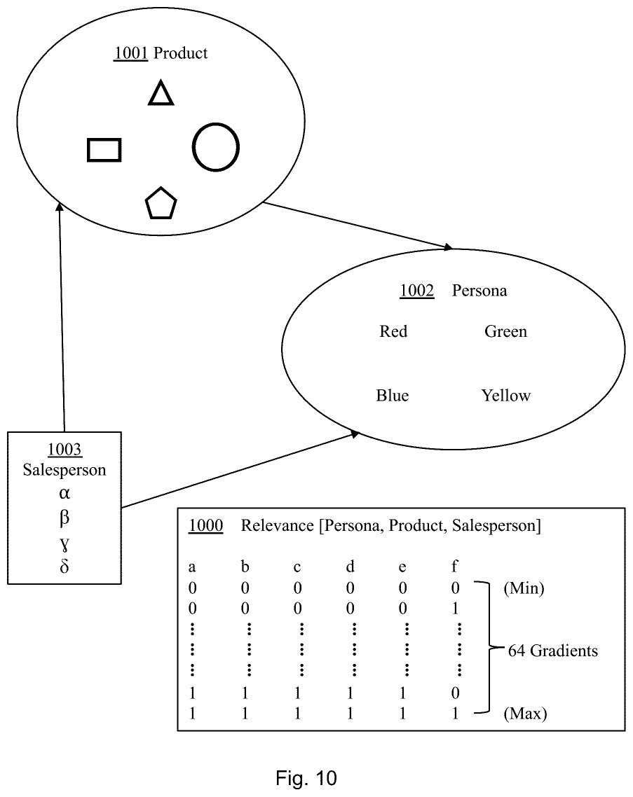

Referring now specifically to FIG. 10, therein illustrated is a block diagram of an exemplary lead assignment organizational plan and schema 1000. Having generated and/or classified a plurality of personas across a plurality of products/services offered by the enterprise, such personas may be classified into, for example, persona schema 1002. Other schema may be provided along products schema 1001 and salesperson schema 1003 in order to maximize exploitation of salespeople resources (which may include human individuals or automated systems, e.g., chatbots, automated calling/text). Such organizational strategies as disclosed therein FIG. 10 may operate under the premise that different salespeople may posses different levels of efficacy in selling different products to different people (i.e., personas) and that optimal conversion, and the technical challenges related to optimizing assignment of sales leads, may be possible when the right salesperson is directed to continue “nudging” the right products to the right personas. FIG. 10 may be thought of by those having ordinary skill in the art as a conceptual view of the product-persona-salesperson grouping with 4 hypothetical personas of persona schema 1002 (e.g., color-coding), 4 hypothetical products of product schema 1001 (e.g., symbol and/or shape coding), and 4 salespeople of salesperson schema 1003 (e.g., symbol coding). The description is not limited to such schema, which are presented for exemplary purposes only, and is not limited in volume except by computing machine power, which may be optimized according to the disclosure herein. Accordingly, certain characteristics may be relevant to salesperson determination in such a schema. For example, flair and willingness of a salesperson may be relevant to orientation toward a particular product and/or service category and efficacy and likability may be relevant to any particular persona. Furthermore, certain features of a product may be relevant to individual personas, such as fitment and interest as herein described. Certain such systems and methods of the disclosure may give due consideration to both logical and emotional factors that may be involved in decisioning by a person and/or persona and therefore, such considerations such as “fitment” between product and persona may be classified along logical planes and “interest” between product and persona may be along an emotional plane. Similarly, flair of a salesperson-product consideration may be classified as logical and willingness may be thought of as emotional. Then along the salesperson-persona consideration, efficacy may be considered logical where likability may be emotional. Such considerations may be important where, for instance, a certain person may be interested in services classified as “triangle” but fitment for certain financial regards may better align such personas with “circle” products/services and certain salespeople may be more willing to sell “pentagon” product/services but may have more flair when selling “triangle” product/services. Such logical planes may be grouped across each of these intersections to include a flair, efficacy and fitment plane and a plane featuring interest, willingness, and likability (i.e., logical vs. emotional planes, respectively). Turning to the chart that covers exemplary schema 1000 with such considerations in mind, (a) may be fitment, (b) may be interest, (c) may be flair, (d) may be willingness, (e) may be efficacy, and (f) may be likability. Then, these values may be assigned on a comply/not comply dichotomy where a “0” indicates non-compliance and “1” denotes compliance. For example, where <a, b, c, d, e, f>: <0, 0, 0, 0, 0, 0>, a population of product offered to a persona by a salesperson nudge may be indicated to not be a good product fit for the persona, the persona is not interested in the product, the salesperson has no flair for the product and is unwilling to sell it, and the salesperson is not effective and is not likable to the personas. This can be observed at the top of example schema 1000. Conversely, <a, b, c, d, e, f>: <1, 1, 1, 1, 1, 1> may indicate the opposite. Given a total of 64 gradients may be formed, these may be color coded in certain visual interfaces and proceed from, for example, deep red indicating poor/no relevance to deep green indicating optimal relevance in the product-salesperson-persona arrangement. Importantly, such gradients may not be limited to 64 shades, but in such a schema may be formulated into any multiple of 64, such as 64, 128, 256, 512, and so on, where each state may be mapped to 1, 2, 4, 8, and so on, respectively, using sub-shading. In an example gradient for particular persona-product-salesperson groupings, which may be [Red, Triangle, α], and may serve as a leaf in the greater collection of gradients for all such combinations. The number of leaves in a cardinal catalogue thereof may be obtained by taking the cartesian product of the 3 sets, and in such example where x, y, and z may denote such cardinalities of those sets, the catalogue may contain x×y×z line items, where each line item is a leaf and may be represented as a cardinal gradient from red to green. From a decisioning perspective as to which salesperson to recommend along a certain product/persona dichotomy as a lead granted to the salesperson, such a catalogue may be used prescriptively to advise who (or what) is the best resource possible across all product/persona dichotomies. Having computed interest scores using the various techniques disclosed above, Leads with product affinities and persona categories, a salesperson pool may be identified that can better facilitate conversions. Such decisioning, and such an overall strategy for lead assignment may be better observed and understood by those having ordinary skill in the art through a review of the remaining Drawing and Detailed Description.

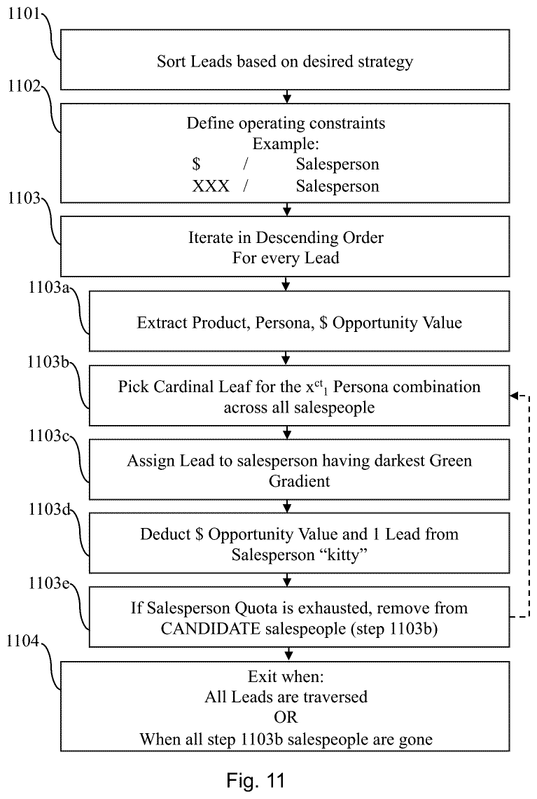

Referring now specifically to FIG. 11, therein illustrated is a flow chart diagram of an exemplary lead assignment strategy. First, leads may be sorted according to business strategies and needs important to the enterprise at step 1101. Such strategies may include maximizing the financial value of each conversion, maximizing the number of conversions, or maximizing sales for a particular product category. Other strategies may be relevant to the considerations and may be developed accordingly or even improvised. Such strategy may then inform operating constraints, such as where the value per conversion may be maximized in the first example and sales of product XXX may be optimized in the second example. Then, steps to iterate every lead in descending order may be performed at step 1103 having sub-steps 1103a-e. As such, the product, persona and opportunity value of each lead may first be extracted at sub-step 1103a. Then, the cardinal leaf as explained above may be picked for the product/persona combination across all salespeople at sub-step 1103b and assigning the lead to the salesperson having the darkest green gradient at step 1103c. Then, that salesperson may have one opportunity value and one lead deducted from their corresponding kitty, as may be understood by those having ordinary skill in the art at step 1103d and continue doing so throughout such processing until that salesperson's lead quota, which may be assigned or calculated, is exhausted after multiple lead assignments at step 1103e. The process may conclude when such processing exhausts all new leads and/or when no salespeople (or sales-entities) remain at step 1104. By implementing a machine learning algorithm upon such gradient decisioning, further utility of such a disclosed process may be enhanced. Such machine learning may be assisted through a process that begins with building a conversion to allocation guidance table based on business knowhow. Such knowhow may be generated or based on discrete conversion metrics for individual salespeople (successful/non-successful conversions versus overall leads), number of days of engagement between each salesperson/lead delivery and conversion or average thereof, relative rank and/or quartile in lead life, and/or gradient range. Additional factors may further be important to certain machine learning and business circumstances. Then, the multi-salesperson attribution guidance described above may be seeded to be either uniform, pro-rata or all-to-last. For each of every fact/history used for the learning algorithm, an allocation vector comprising <salesperson, product, persona, share fraction, gradient> may be emitted and the allocations for the partial vectors of <salesperson, product, persona> and <gradient> and a sum of the total shares may be accrued using a basic tally marks technique may be accrued. The learning algorithm may then obtain the gradient for such a partial vector of <gradient> by a formula such as:

$$\frac{{\sum }_{i = 0}^{n} {share}_{i} * {gradient}_{i}}{{\sum }_{i = 0}^{n} {share}_{i}} .$$

In order to perform the allocation for the partial vector of <gradient> in advance of such a calculation, a gradient value between a chosen subset, for example 56-64 may be chosen at random and denoted as a fraction of the chosen number over 64. In such uniform strategies, pro rata strategies, and all-all-to last strategies, shares may be assigned to salespersons according to 0.33, by dividing days assigned to a salesperson by overall days assigned to other salespeople in a group of salespeople, or 1, respectively.

With respect to the above description then, it is to be realized that the optimum methods, systems and their relationships, to include variations in systems, machines, size, materials, shape, form, position, function and manner of operation, assembly, order of operation, type of computing devices (mobile, server, desktop, etc.), type of network (LAN, WAN, internet, etc.), size and type of database and/or services provisioned, data-type stored therein databases, and uses thereof, are intended to be encompassed by the present disclosure.

In select embodiments, additional digital interactions, channels, profiles, traits, engagements, entities, interests, experiences, observations, gamification strategies, product lines, and leads may be of interest. Variation may exist among the described additional digital interactions, channels, profiles, traits, engagements, entities, interests, experiences, observations, gamification strategies, product lines, and leads. The subject matter of the disclosure is not limited to one particular industry, business type, website, social media platform, or entertainment platform, and the systems and methods disclosed herein are not limited in utility to social media, streaming platforms, financial institutions, and the mobile telecommunications sector. Relevant sectors for use of the system and method of the disclosure may also include banking, finance, residential/business telecommunications, utilities (e.g., electric, water, gas), healthcare, entertainment, broadcast media, other forms of social media not recited herein, the like and/or combinations thereof.

The foregoing description and drawings comprise illustrative embodiments of the present disclosure. Having thus described exemplary embodiments, it should be noted by those ordinarily skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments of the disclosure will come to mind to one ordinarily skilled in the art to which this disclosure pertains having the benefit of the teachings presented in the foregoing descriptions and the associated drawings. Although specific terms may be employed herein, they are used in a generic and descriptive sense only and not for purposes of limitation. Moreover, the present disclosure has been described in detail, it should be understood that various changes, substitutions and alterations can be made thereto without departing from the spirit and scope of the disclosure as defined by the appended claims. Accordingly, the present disclosure is not limited to the specific embodiments illustrated herein, but is limited only by the following claims.

1. A computer system for optimizing a user engagement between a plurality of users and a digital services platform in receipt of a continuous real-time digital interaction stream from the plurality of users, the computer system comprising:
a memory device for storing a plurality of data from the continuous real-time digital interaction stream;
a non-transitory computer readable medium;
a network connection capable of receiving the continuous real-time digital interaction stream; and
a processor in communication with said memory device, said non-transitory computer readable medium, and said network connection is configured to configured to:
continuously perform a streaming ingestion of the real-time digital interaction stream;
obtain a prime number sieve having a plurality of prime numbers and a plurality of symbols;
continuously encode the real-time digital interaction stream for each of the plurality of users for each of a plurality of discrete user interactions to each of said plurality of prime numbers and each of said plurality of symbols;
continuously string a resulting plurality of encoded symbols for each of said plurality of users into a symbol string; and
continuously multiply a resulting plurality of encoded prime numbers to form a prime number product;
wherein the real-time digital interaction stream includes at least a digital services platform service-type from a plurality of digital services, a user activity, and an interaction source-type, and wherein the processor is configured to analyze and process the continuous real-time digital interaction stream in real-time to obtain a noise score and a focus score in relation to each of said plurality of users and each of said plurality of digital services.

2. The system of claim 1, wherein said user activity is an at least one user activity from a group of user activities, the group of user activities consisting of a clicking on a hyperlink, a scrolling, a hovering, a waiting, and an inputting information.

3. The system of claim 2, wherein said interaction source-type is an at least one interaction source-type from a group of interaction source types, the group of interaction source types consisting of a mobile browser user interaction, a user computing device browser interaction, a mobile application interaction, a computing device application interaction, and a social media interaction.

4. The system of claim 3, further comprising a machine-learning module installed on said non-transitory computer readable medium, said machine learning module configured to, via said processor, cluster said symbol string and said prime number product across each of said plurality of users to form a plurality of clusters, said plurality of clusters having either of a greatest common denominator of said prime product or a common subsequence of said symbol string.

5. The system of claim 4, wherein said computer system is further configured to obtain said plurality of clusters via said machine-learning module installed thereon said non-transitory computer readable medium by:
obtaining a sample “s” of said plurality of users, said sample “s” having a size “n”;
computing a greatest common denominator of said sample “s”;
obtaining a plurality of subsamples from said sample “s”;
computing a series of greatest common denominator functions upon said resulting plurality of encoded prime-numbers of said plurality of subsamples to obtain a plurality of GCDs;
calculating a mean thereof said resulting plurality of encoded prime numbers of said plurality of subsamples; and
computing a sample synergy (Φ) using a formula comprising:
$$\frac{{\sum }_{1}^{H - 1} Φ i + 1 / {Φ}_{i}}{H - 1} ,$$
wherein
“H” is defined a closest greater integer of the formula log₂ n/4.

6. The system of claim 5, wherein said processor is further configured to obtain a noise score (μ) and a focus score (ζ) for said sample from said plurality of users.

7. The system of claim 6, wherein each of said noise score is obtained via an equation comprising:
$$μ = \frac{\frac{l ( {S}_{C 1} )}{\vert {S}_{C 1} \vert} + \frac{l ( {S}_{C 2} )}{\vert {S}_{C 2} \vert} + … \frac{l ( {S}_{Cn} )}{\vert {S}_{Cn} \vert}}{n} ,$$
and wherein (n) is a number of clusters, (S) is said common subsequence of each of said cluster, and (l) is a Levenshtein distance of each of said common subsequence of each of said cluster.

8. The system of claim 7, wherein said focus score (ζ) is obtained via an algorithm comprising:
seeding a positive value for ζ when μ is negative;
seeding a negative value for ζ when μ is positive;
seeding a 0 value for ζ when μ is 0; and
iterating said focus score upward by an increment when μ is trending downward and
iterating said focus score downward by an increment when μ is trending upward.

9. The system of claim 8, wherein an interest score (ψ) is obtained and continuously updated via a formula comprising one of:
ψ=1/e(μ*ζ+ζ*ζ) and ψ=1/e(μ*ζ+ζ*ζ+0.5μ), and the processor is further configured to assign a persona to each of said plurality of clusters, thereby assigning a plurality of personas.

10. The system of claim 8, further comprising enabling a digital communications platform within each of said plurality of clusters.

11. The system of claim 8, further comprising a lead assignment module stored on said non-transitory computer readable medium for a plurality of sales entities, said assignment module configured to via said processor:
assign a logical value and an emotional value to an association between each of:
said plurality of sales entities and said plurality of digital services;
said plurality of sales entities and said plurality of personas; and
said plurality of personas and said plurality of digital services;
select a sales entity for a lead, said sales entity having a strongest said association of said plurality of sales entities.

12. A method for optimizing a user engagement between a plurality of users and a digital services platform using a computer system in receipt of a continuous real-time digital interaction stream from the plurality of users, the method comprising:
obtaining said computer system having a processor, a memory device for storing a plurality of data from the continuous real-time digital interaction stream, a non-transitory computer readable medium, and a network connection capable of receiving the continuous real-time digital interaction stream;
continuously performing a streaming ingestion of the real-time digital interaction stream;
obtaining a prime number sieve having a plurality of prime numbers;
obtaining a plurality of symbols;
continuously encoding the real-time digital interaction stream for each of the plurality of users for each of a plurality of discrete user interactions to each of said plurality of prime numbers and each of said plurality of symbols;
continuously stringing a resulting plurality of encoded symbols for each of said plurality of users into a symbol string; and
continuously multiplying a resulting plurality of encoded prime numbers to form a prime number product;
wherein the real-time digital interaction stream includes at least a digital services platform service-type from a plurality of digital services, a user activity, and an interaction source-type, and wherein the processor is configured to analyze and process the continuous user activity stream in real-time to obtain a noise score and a focus score in relation to each of said plurality of users and each of said plurality of digital services.

13. The method of claim 12, wherein said user activity is an at least one user activity from a group of user activities consisting of a clicking on a hyperlink, a scrolling, a hovering, a waiting, and an inputting information and wherein said interaction source-type is an at least one interaction source-type from a group of interaction source types consisting of a mobile browser user interaction, a user computing device browser interaction, a mobile application interaction, a computing device application interaction, and a social media interaction.

14. The method of claim 13, further comprising installing a machine-learning module on said non-transitory computer readable medium, and via said machine learning module clustering said symbol string and said prime number product across each of said plurality of users to form a plurality of clusters, said plurality of clusters having either of a greatest common denominator of said prime product or a common subsequence of said symbol string.

15. The method of claim 14, further comprising obtaining said plurality of clusters via said machine-learning module installed thereon said non-transitory computer readable medium by:
obtaining a sample “s” of said plurality of users, said sample “s” having a size “n”;
computing a greatest common denominator of said sample “s”;
obtaining a plurality of subsamples from said sample “s”;
computing a series of greatest common denominator functions upon said resulting plurality of encoded prime-numbers of said plurality of subsamples to obtain a plurality of GCDs;
calculating a mean thereof a resulting plurality of encoded prime numbers of said plurality of subsamples; and
computing a sample synergy (Φ) using a formula comprising:
$$\frac{{\sum }_{1}^{H - 1} Φ i + 1 / {Φ}_{i}}{H - 1} ,$$
wherein
“H” is defined a closest greater integer of the formula log₂ n/4.

16. The method of claim 15, further comprising obtaining a noise score (μ) and a focus score (ζ) for said sample from said plurality of users.

17. The method of claim 16, further comprising obtaining each of said noise score via an equation comprising:
$$μ = \frac{\frac{l ( {S}_{C 1} )}{\vert {S}_{C 1} \vert} + \frac{l ( {S}_{C 2} )}{\vert {S}_{C 2} \vert} + … \frac{l ( {S}_{Cn} )}{\vert {S}_{Cn} \vert}}{n} ,$$
wherein (n) is a number of clusters from a plurality of clusters, (S) is said common subsequence of each of said cluster, and (l) is a Levenshtein distance of each of said common subsequence of each of said plurality of clusters.

18. The method of claim 17, further comprising obtaining said focus score (ζ) via an algorithm comprising:
seeding a positive value for ζ when μ is negative;
seeding a negative value for ζ when μ is positive;
seeding a 0 value for ζ when μ is 0; and
iterating said focus score upward by an increment when μ is trending downward and iterating said focus score downward by an increment when μ is trending upward.

19. The method of claim 18, further comprising obtaining an interest score (ψ) and continuously updating said interest score (ψ) via a formula comprising one of:
ψ=1/e(μ*ζ+ζ*ζ) and ψ=1/e(μ*ζ+ζ*ζ+0.5μ), and assigning a persona to each of said plurality of clusters, thereby assigning a plurality of personas.

20. The system of claim 18, further comprising enabling a digital communications platform within each of said plurality of clusters.
